(19) United States
(12) Patent Application Publication
(10) Pub. No.: US 2022/0334309 A1
(43) Pub. Date: Oct. 20, 2022

(54) Optical Waveguide Element

(71) Applicant: Nippon Telegraph and Telephone Corporation, Tokyo (JP)

(72) Inventors: Yu Kurata, Musashino-shi, Tokyo (JP); Yuichiro Ikuma, Musashino-shi, Tokyo (JP)

(21) Appl. No.: 17/638,712

(22) PCT Filed: Sep. 3, 2019
(86) PCT No.: PCT/JP2019/034620

§ 371 Date: Feb. 25, 2022

(51) Int. Cl. G02B 6/12

(52) U.S. Cl. CPC G02B 6/12014

(57) ABSTRACT

Provided is an optical waveguide component that may couple optical waveguides simply at low optical coupling loss when configuring a photoelectron integration device by means of hybrid integration by coupling an optical element. In the component, groove portions deeper than a core of an optical waveguide are provided in parallel on both sides of the core in an extending direction of the optical waveguide that covers the core. A refractive index of a medium that occupies the groove portions is lower than a refractive index of an underclad and an overclad to equivalently increase a difference in refractive index between the core and both the underclad and the overclad. Accordingly, confinement of light propagating through the core of the optical waveguide can be enhanced, and a mode field of the propagating light can be adjusted so as to become smaller.

### TECHNICAL FIELD

The present invention relates to an optical waveguide component that is applicable to an optical communication system and is used when mounting an optical element such as a photodiode or laser diode.

### BACKGROUND ART

In recent years, as optical fiber transmission becomes popular, a technology for integrating a large number of optical function elements at a high density is required. As one of such technologies, a quartz-based planar lightwave circuit (hereinafter referred to as PLC) is known. The PLC is a waveguide optical device having excellent characteristics such as low loss, high reliability, and high design flexibility, and a PLC in which functions such as a multiplexer/demultiplexer and a splitter/coupler are integrated is actually mounted on a transmission apparatus at an optical communication transmission end.

In addition, as an optical device other than the PLC, an optical element that converts between light and an electric signal, such as a photodiode (hereinafter referred to as PD) or laser diode (hereinafter referred to as LD), is also mounted on the transmission apparatus. Furthermore, for increasing channel capacity, a sophisticated photoelectron integration device in which an optical waveguide such as a PLC that performs optical signal processing and an optical device such as a PD that performs photoelectric conversion are integrated is required.

The PLC is promising as a platform of such an integration optical device. Well-known technologies thereof include “OPTICAL WAVEGUIDE COMPONENT AND MANUFACTURING METHOD THEREFOR” (see Patent Literature 1) in which chips of a PD and a PLC are integrated in a hybrid manner.

### CITATION LIST

### Patent Literature

Patent Literature 1: Japanese Patent Laid-Open No. 2005-70365

### SUMMARY OF THE INVENTION

### Technical Problem

This Patent Literature 1 discloses a technology of providing a 45° mirror as an optical path conversion unit in a partial region of an optical waveguide, and mounting a PD on the optical waveguide, thereby converting the optical path of light propagating through the optical waveguide with the 45° mirror at the right angle to achieve optical coupling with the PD.

A photoelectron integration device in which a PLC and an optical element such as a PD are combined and mounted in this manner is advantageous in terms of size reduction and circuit design flexibility. Furthermore, in recent years, in order to increase the channel capacity further, a photoelectron integration device is required to have a function that may couple a plurality of arrayed optical elements so as to achieve low loss in a PLC provided with a function of multiplexing/demultiplexing optical signals to adapt to multiple channels.

In the above-described photoelectron integration device of Patent Literature 1, assume abutting and coupling respective optical waveguides of the PLC and the optical element, for example. In this case, a quartz-based glass which is the material of the optical waveguide of the PLC has a refractive index of approximately 1.5, while the material of the optical waveguide of the optical element, such as a compound semiconductor such as InP, or Si, has a refractive index of more than or equal to 3, and the refractive indices are significantly different.

Therefore, in a case of manufacturing a single mode waveguide of the material of each of the optical waveguides, the optical waveguide of the optical element higher in refractive index achieves stronger confinement of light. Thus, the optical element is smaller in mode field diameter (MFD) of light propagating through the optical waveguide than the PLC.

In this manner, in a case of abutting and coupling optical waveguides having different mode field diameters to constitute a photoelectron integration device, a mismatch in mode field will cause optical loss, resulting in property deterioration. Thus, in order to take measures against such an optical loss problem, it is necessary to increase the mode field diameter of the optical element, for example, to decrease the mismatch and control optical loss.

FIG. 1 is a partially broken perspective view illustrating a manner of configuring a well-known photoelectron integration device by coupling an optical waveguide component 10 and an optical element 20 having cores different in mode field diameter, in a state before coupling.

With reference to FIG. 1, the optical waveguide component in this photoelectron integration device is provided with an optical waveguide 2 on a main surface of a substrate 1. The optical waveguide 2 has an underclad 2a, a core 3, and an overclad 2b as laminated, and enables a signal to be input/output to/from the optical element 20 coupled to the vicinity of an end surface of the substrate 1. The optical element 20 is configured such that a core 3′ having a double structure in which a linear quadrangular plate-like portion 3b′ extending linearly is coupled to a quadrangular plate-like portion 3a′ having a tapering shape is covered by a clad 2c.

The core 3 of the optical waveguide 2 of the optical waveguide component 10 and the core 3′ of the optical element 20 are optically coupled in an abutting direction M. Thus, the core 3′ of the optical element 20 is provided with a function as a spot-size converter (SSC) that increases the mode field. In the example illustrated in FIG. 1, the core 3′ of the optical element 20 has a double structure, and the quadrangular plate-like portion 3a′ on the optical input side has a tapering shape to reduce the width of the core 3′, thereby controlling optical loss when optically coupled to the core 3 of the optical waveguide 2.

For such measures for controlling optical loss, a structure in which the core 3′ is tapered so as to increase the width may be adopted, or a structure in which the periphery of the core 3′ is covered by SiO₂ to provide a double core may be adopted, depending on circumstances. In any way, a range in which a production step is prevented from being relatively complicated is desirable. With such mode field measures taken for the core 3′ on the optical element 20 side, however, an increase to a mode field that can sufficiently reduce optical loss is often difficult.

In contrast, as to the mode field on the side of the optical waveguide component 10 such as a PLC, as the diameter of the core 3 under a single mode condition is decreased, light confinement is weakened, which acts in a direction that the mode field is increased. Thus, it is generally difficult to reduce the mode field. Alternatively, a technique for increasing a difference in refractive index between the core 3 and the clad (indicating the underclad 2a or the overclad 2b) in the optical waveguide component 10 to reduce the mode field is also conceivable. In this case, when the difference in refractive index is changed, properties of the optical circuit (the optical waveguide 2) included in the optical waveguide component 10 are also changed, so that it will be difficult to maintain the properties.

In this manner, when abutting and mounting the optical waveguide component 10 such as the PLC and the optical element 20, a mismatch in mode field between the optical waveguides occurs even if a spot-size converter that can be achieved through a relatively easy step is used for the optical element 20. Thus, there is a problem in that it is difficult to simply achieve reduction of optical loss. Therefore, if a more complicated structure is adopted for the spot-size converter of the optical element 20, there is room for increasing the mode field further. However, when such a structure is adopted, a problem arises in that the production step is complicated in contrast. Consequently, such a technique is not considered as a suitable technique from the perspective of simply achieving low optical loss.

In conclusion, in a case of configuring a photoelectron integration device by means of hybrid integration of coupling the optical element 20 using the optical waveguide component 10 as a platform, an optical waveguide component that may couple optical waveguides simply at low optical coupling loss has not been achieved under the current conditions.

### Means for Solving the Problem

Embodiments according to the present invention were made to solve the above problems. The embodiments according to the present invention have an object to provide an optical waveguide component that may couple optical waveguides simply at low optical coupling loss when configuring a photoelectron integration device by means of hybrid integration by coupling an optical element.

In order to achieve the above object, an aspect of the present invention is an optical waveguide component including an optical waveguide on a main surface of a substrate, the optical waveguide having an underclad, a core, and an overclad as laminated, and enabling a signal to be input/output to/from an optical element coupled to a vicinity of an end surface of the substrate. The optical waveguide component includes groove portions on both sides of the core of the optical waveguide in a vicinity of the end surface of the substrate in a horizontal direction, the groove portions being formed deeper than the core in a cross-sectional direction with respect to a vertical direction of the substrate, and provided in parallel in an extending direction of the optical waveguide that covers the core, in which a refractive index of a medium that occupies the groove portions is lower than a refractive index of the underclad and the overclad.

When configuring a photoelectron integration device by means of hybrid integration by coupling an optical element, the optical waveguide component having the above configuration enables optical waveguides to be coupled simply at low optical coupling loss.

### BRIEF DESCRIPTION OF DRAWINGS

FIG. 1 is a partially broken perspective view illustrating a manner of configuring a well-known photoelectron integration device by coupling an optical waveguide component and an optical element having cores different in mode field diameter, in a state before coupling.

FIG. 2 is a partially broken perspective view illustrating a manner of configuring a photoelectron integration device according to a first embodiment of the present invention by coupling an optical waveguide component and an optical element having cores different in mode field diameter, in a state before coupling.

FIG. 3 is a perspective view illustrating a manner of optically coupling a PLC to which the structure of the optical waveguide component illustrated in FIG. 2 is applied and a PD which is an application example of an optical element.

FIG. 4 is a partially broken perspective view illustrating a detailed structure of the optical waveguide of the PLC illustrated in FIG. 3 on an exit region side.

FIG. 5 is a drawing illustrating a correspondence relation between a result of inputting light to the PLC illustrated in FIG. 3 and measuring the mode field diameter at an end surface of a substrate of an optical waveguide for each channel and the distance between a side surface of a core and an adjacent side surface of groove portions.

FIG. 6 illustrates a result of obtaining light receiving sensitivity from a photocurrent of each channel of the PD measured when coupling the PLC and the PD illustrated in FIG. 3, and calculating optical coupling loss with respect to the above-described distance.

FIG. 7 is a perspective view illustrating a manner of optically coupling a PLC according to a second embodiment of the present invention and a PD which is an application example of an optical element.

FIG. 8 is a partially broken perspective view illustrating a detailed structure of an optical waveguide of the PLC illustrated in FIG. 7 on the exit region side.

FIG. 9 is a drawing illustrating a correspondence relation between a result of inputting light to the PLC illustrated in FIG. 7 and measuring the mode field diameter at an end surface of a substrate of the optical waveguide for each channel and the width of a core on the exit region side.

FIG. 10 illustrates a result of obtaining light receiving sensitivity from a photocurrent of each channel of the PD measured when coupling the PLC and the PD illustrated in FIG. 7, and calculating optical coupling loss with respect to the width of the core in the above-described exit region.

### DESCRIPTION OF EMBODIMENTS

Hereinafter, optical waveguide components according to embodiments of the present invention will be described in detail with reference to the drawings using some embodiments.

### First Embodiment

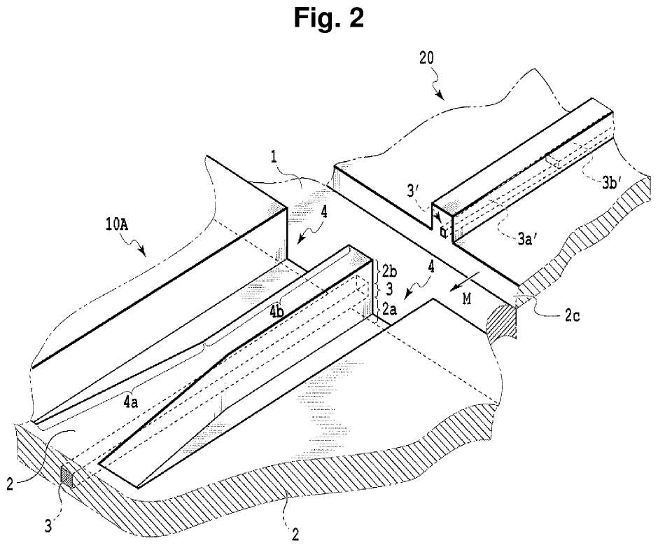

FIG. 2 is a partially broken perspective view illustrating a manner of configuring a photoelectron integration device according to a first embodiment of the present invention by coupling an optical waveguide component 10A and an optical element having cores different in mode field diameter, in a state before coupling.

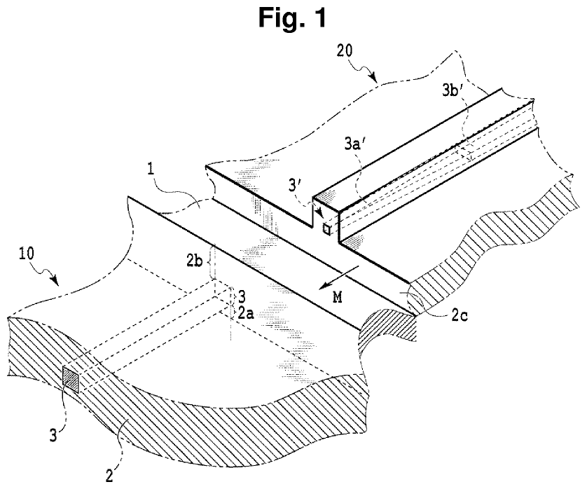

With reference to FIG. 2, the optical waveguide component 10A in this photoelectron integration device is also provided with the optical waveguide 2 on a main surface of the substrate 1 made of Si or the like. The optical waveguide 2 herein also has the underclad 2a, the core 3, and the overclad 2b as laminated, and enables a signal to be input/output to/from the optical element 20 coupled to the vicinity of an end surface of the substrate 1. The optical element 20 is the same as the configuration described with reference to FIG. 1, and is configured such that the core 3′ having a double structure in which the linear quadrangular plate-like portion 3b′ extending linearly is coupled to the quadrangular plate-like portion 3a′ having a tapering shape is covered by the clad 2c.

In the case of this optical waveguide component 10A, on both sides of the core 3 of the optical waveguide 2 in the vicinity of the end surface of the substrate 1 in the horizontal direction, groove portions 4 deeper than the core 3 in the cross-sectional direction with respect to the vertical direction of the substrate 1 are provided in parallel in an extending direction of the optical waveguide 2 that covers the core 3. However, the refractive index of a medium that occupies these groove portions 4 is lower than the refractive index of the underclad 2a and the overclad 2b. Such a medium may be highly versatile air. The groove portions 4 indicate regions sufficiently wider than the mode field on both the sides of the core 3 in the horizontal direction on the main surface of the substrate 1, the region having a bottom surface deeper than the core 3 in a direction vertical to the main surface of the substrate 1, which also applies below.

The groove portions 4 have a tapering shape. This tapering shape is formed such that the distance between a side surface of the core 3 of the optical waveguide 2 in the horizontal direction of the substrate 1 and an adjacent side surface of the groove portions 4 provided on both the sides of the optical waveguide 2 of the substrate 1 decreases from the opposite side of the end surface of the substrate 1 toward the end surface. Accordingly, the groove portions 4 are in the form in which a tapering recess 4a on the opposite side of the end surface of the substrate 1 and a linear recess 4b extending linearly toward the end surface of the substrate 1 connect to each other. In addition, an end of the linear recess 4b of the groove portion 4 on the end surface side of the substrate 1 is a cut-out space having no wall. Note that the distance between a side surface of the core 3 of the optical waveguide 2 in the horizontal direction of the substrate 1 and an adjacent side surface of the groove portions 4 provided on both the sides of the core 3 can be defined with reference to the width of the core 3. Such a distance preferably is less than or equal to ½ of the width of the core 3 in a direction vertical to the extending direction of the core 3, and more than zero.

Also in this optical waveguide component 10A, the core 3 of the optical waveguide 2 and the core 3′ of the optical element 20 are optically coupled in the abutting direction M. Thus, similarly to the case described with reference to FIG. 1, the core 3′ of the optical element 20 is provided with the function as a spot-size converter (SSC) that increases the mode field. Also in the example illustrated in FIG. 2, the core 3′ of the optical element 20 has a double structure, and the quadrangular plate-like portion 3a′ on the optical input side has a tapering shape to reduce the width of the core 3′, thereby controlling optical loss when optically coupled to the core 3 of the optical waveguide 2. However, with mode field measures taken for the core 3′ on the optical element 20 side, it is difficult to achieve an increase to a mode field that sufficiently reduces optical loss, as described above.

In this respect, in the optical waveguide component 10A according to the first embodiment, the groove portions 4 provided on both the sides of the core 3 of the optical waveguide 2 of the substrate 1 are occupied by a medium having a refractive index lower than those of the underclad 2a and the overclad 2b. Thus, the mode field of light propagating through the optical waveguide can be adjusted to be smaller in the optical waveguide 2. Accordingly, optical loss due to a mismatch in mode field can be reduced. Note that this optical waveguide component 10A is suitably applied to a PLC.

In the meanwhile, in order to reduce the mode field more effectively, it is desirable that the width of the core 3 of the optical waveguide 2 in the horizontal direction of the substrate 1 be smaller than the width of the core 3′ of the optical waveguide of the optical element 20 to be connected to the optical waveguide 2. In addition, as described above, it is desirable that the distance between a side surface of the core 3 of the optical waveguide 2 and an adjacent side surface of the groove portions 4 provided on both the sides of the core 3 be less than or equal to ½ of the width of the core 3 on one side. Furthermore, it is desirable that the height of the core 3 in the vertical direction of the substrate 1 of the optical waveguide 2 be smaller than the height of the core 3′ of the optical waveguide of the optical element 20 to be connected to the optical waveguide 2.

Herein, when reducing the mode field, optical loss will occur at a connected portion if there is a mismatch between respective mode fields of the optical waveguide 2 and the optical waveguide of the optical element 20 to be connected to the optical waveguide 2. Therefore, a tapering shape may be introduced in which the distance between a side surface of the core 3 of the optical waveguide 2 in the horizontal direction of the substrate 1 and an adjacent side surface of the groove portions 4 provided on both the sides of the core 3 decreases from the opposite side of the end surface of the substrate 1 toward the end surface. Accordingly, the mode field can be gradually converted toward the optical waveguide 2 at the end surface of the substrate 1. At this time, in a case of reducing the width of the core 3 of the optical waveguide 2, it is desirable to similarly adopt a tapering structure for the width of the core 3 as well to gradually change the width of the core 3.

In general, the cross-sectional structure of the PLC is such that thin films of SiO₂ are deposited on the main surface of the substrate 1 made of Si, SiO₂, or the like by about 20 μm as the underclad 2a, by 3 to 10 μm as the core 3, and by about 20 μm as the overclad 2b. Assuming the optical waveguide 2 formed in the end surface region of the substrate 1 as an input/output waveguide through which light is input/output, optical coupling is performed with the mode field at the end surface of the substrate 1. In order to obtain a small mode field at the end surface of the substrate 1, the groove portions 4 extending in the traveling direction of light propagating through the input/output waveguide in the direction horizontal to the substrate 1 of the PLC are provided on both sides of the input/output waveguide. In order to effectively reduce the mode field, it is desirable that the inside of the groove portions 4 is occupied by a medium such as air, resin, or the like having a refractive index lower than that of the clad material of the underclad 2a and the overclad 2b.

In addition, it is desirable that the depth of the groove portions 4 in the direction vertical to the substrate 1 of the PLC be deeper than the depth of the bottom surface of the core 3. Accordingly, by increasing an equivalent refractive index in a base mode of light propagating through the core 3, a strong light confinement effect is obtained. As a result, the mode field can be reduced, and an effective action is particularly exerted on the mode field in the horizontal direction of the substrate 1. In order to provide such groove portions 4 for mode field adjustment, a technique through use of patterning and dry etching through photolithography is used for a region in which the groove portions 4 are to be provided. Consequently, simple implementation can be achieved without requiring a special step.

Furthermore, the above structure is a structure to be applied only to the input/output waveguide portion, and is thus easily introduced into the design of an existing PLC. Since a groove portion forming step targeted at the PLC is also performed in forming a heat insulating groove portion in an optical switch through use of the thermooptical effect of the PLC, the heat insulating groove portion and the groove portions 4 for mode field adjustment can be formed at the same time. In such a case, implementation without adding any step is possible. For example, the optical waveguide 2 has a structure in which the groove portions 4 are not provided on both the sides of the core 3 in a section from an optical circuit region to an input/output region of the optical coupling end surface in which the groove portions 4 are provided. In addition, a suitable example of the optical waveguide 2 is a case of having a structure in which a clad resulting from at least either of the underclad 2a and the overclad 2b is left in the input/output region with the interposition of the groove portions 4 on both the sides of the core 3.

Usually, in order to reduce the mode field, a technique for producing the PLC using a core material having a high refractive index, or additionally depositing a second core material having a high refractive index on the input/output waveguide portion, and then performing core shape processing is used. However, the former of these techniques raises a problem in that the optical circuit needs to be designed again, and at the same time, optical coupling loss with optical fibers used for input/output of a signal to/from an element other than the optical element 20 increases due to a mismatch in mode field. The latter raises a problem in that not only performing deposition and processing of the additional core material, but also removal of the second core material deposited in an extra region needs to be removed at an accuracy less than or equal to a submicron, which complicates the production step of the PLC. In contrast, the technique of the first embodiment can be introduced without changing the design of the optical circuit region of the PLC, and can be achieved in a simple production step.

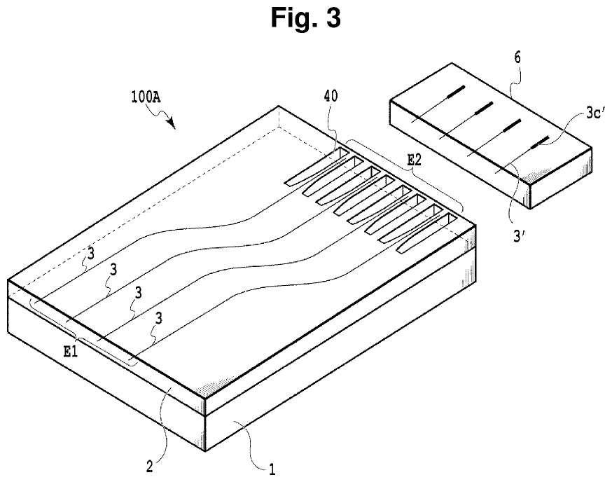

FIG. 3 is a perspective view illustrating a manner of optically coupling a PLC 100A to which the structure of the above-described optical waveguide component 10A has been applied and a PD 6 which is an application example of the optical element 20. This PLC 100A is made of a quartz-based material in which the optical waveguide 2 according to the following standard is formed on the main surface of the substrate 1 made of Si. That is, as the standard for the optical waveguide 2, assume that the vertical dimension is 5 mm and the horizontal dimension is 10 mm, the diameter of the core 3 is 4.5 μm, the film thickness of the overclad 2b as seen from the upper surface of the core 3 is 15.5 μm, and the film thickness of the underclad 2a underlying the core is 20 μm. In addition, a case of the optical waveguide 2 in which a difference in refractive index between the core 3 and both the underclad 2a and the overclad 2b is 2.0% can be shown as an example.

In the optical waveguide 2 in this PLC 100A, optical input is performed through an entrance region E1 on the near side in FIG. 3 that is provided on a shorter side of the substrate 1, and optical output is performed through an exit region E2 on the farther side in FIG. 3 that is formed on a shorter side on the opposite side of the entrance region E1. The optical waveguide 2 adopts a structure in which the cores 3 for four channels are provided at a pitch of 250 μm, and the cores 3 from the entrance region E1 side to reach the vicinity of a portion in which a total of eight groove portions 40 are formed are S-shaped portions. Accordingly, the cores 3 have a structure in which the linear portion located in a gap between the groove portions 40 and the S-shaped portion are coupled in the direction in which the groove portions 40 extend. In addition, the structure of the groove portions 40 herein is different in detail from the case of the structure of the groove portions 4 of the optical waveguide component 10A described with reference to FIG. 2. The groove portions 40 illustrated in FIG. 3 are formed to a position offset from the end surface, rather than extending through to the end surface of the substrate 1 on the optical output side.

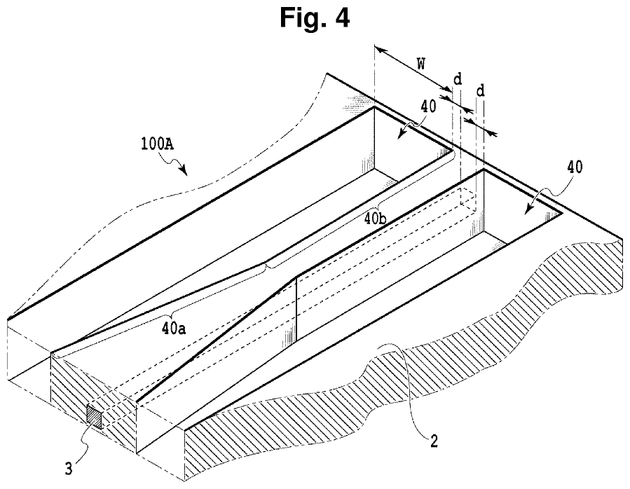

FIG. 4 is a partially broken perspective view illustrating a detailed structure of the optical waveguide 2 of the PLC 100A illustrated in FIG. 3 on the exit region E2 side. With reference to FIG. 4, the groove portions 40 provided on both the sides of the linear portion of the core 3 have a total length of 500 μm toward the end surface of the substrate 1 in the direction of optical output of the core 3, and are formed to a position of 5 μm from the wall of the end surface of the substrate 1 that serves as the exit region E2. That is, the groove portions 40 are structured to have a wall without extending through the end surface of the substrate 1 that serves as the exit region E2. Note that the end surface of the substrate 1 may be called a chip end.

That is, these groove portions 40 also have a shape having a tapering recess 40a and a linear recess 40b, each of which is formed to have a length of 250 μm. That is, in the groove portions 40, the tapering recess 40a on the opposite of the end surface of the substrate 1 on the exit region E2 side is formed to reach a position of 250 μm from a position of the linear recess 40b on the end surface side of the substrate 1 on the exit region E2 side. However, the dimensions and shapes of the tapering recess 40a and the linear recess 40b indicate a mere example, and can be changed arbitrarily.

Furthermore, on the exit region E2 side of the groove portions 40, a distance d between a side surface of the core 3 and an adjacent side surface of the linear recess 40b is set constant. However, in the case in which a plurality of the cores 3 are provided as illustrated in FIG. 3, the distance d between a side surface of the cores 3 and an adjacent side surface of the linear recess 40b can be changed for each of the cores 3. In addition, the tapering structure of the tapering recess 40a of the groove portion 40 is set such that the distance d between a side surface of the core 3 and an adjacent side surface of the tapering recess 40a increases gradually toward the opposite side of the end surface of the substrate 1. The distance d between a side surface of the core 3 and an adjacent side surface of the tapering recess 40a is 10 μm presenting a maximum value at an end of the tapering recess 40a on the opposite side of the end surface of the substrate 1. Accordingly, the groove portion 40 is shaped such that the tapering recess 40a and the linear recess 40b are formed continuously, and has a minimum width at the end of the tapering recess 40a most distant from and on the opposite side of the end surface of the substrate 1. Note that the linear recess 40b of the groove portion 40 has a width W of 50 μm.

Thus, for the cores 3 for four channels illustrated in FIG. 3, the distance d between a side surface of the cores 3 in the exit region E2 and an adjacent side surface of the linear recess 40b of the groove portion 40 is set at 0 μm, 1 μm, 2 μm, and 3 μm, respectively. The groove portions 40 are formed by dry etching so as to have a depth deeper than the core 3. Although operations and effects are not limited by the method of producing the groove portions 40, a highly accurate and highly flexible layout can be achieved if the groove portions 40 are produced by dry etching. Each of the groove portions 4 provided in the above-described optical waveguide component 10A and the groove portions 40 provided in the PLC 100A may be regarded as being filled with air unless otherwise specified.

In the PD 6 to be abutted on and coupled to the PLC 100A having such a structure, the optical waveguide is provided with a spot-size converter. Describing specifically with reference to FIG. 3, the core 3′ whose mode field diameter at full width at which the intensity of a light intensity distribution is 1/e² is 3 μm in each of the vertical direction and the horizontal direction of the chip is intended for optical input, and is coupled to a photoelectric conversion portion 3c′. Light input to the core 3′ through the spot-size converter propagates through the optical waveguide of the PD 6, and is converted into an electric signal in the photoelectric conversion portion 3c′. Note that the light receiving sensitivity of the PD 6 alone excluding optical coupling loss is 1.0 A/W at a wavelength of 1.55 μm.

When abutting and coupling the PLC 100A and the PD 6, the positions of the optical waveguide 2 of the PLC 100A and the optical waveguide of the PD 6 are aligned so as to maximize the light receiving sensitivity of the PD 6 with respect to light output from the output region E2 of the core 3 of the PLC 100A. Then, a resin that is transparent in an infrared region close to the refractive indices of the core 3 of the PLC 100A and the underclad 2a and the overclad 2b is charged between the PLC 100A and the PD 6. The resin is then cured to achieve securing and fixation. The photoelectron integration device can be configured in this manner. However, an antireflection film corresponding to the refractive index of the resin to be charged is preferably provided at the end surface to serve as the optical waveguide of the PD 6.

By coupling the PLC 100A and the PD 6, a four-channel integration light receiving device is configured. Light input to the entrance region E1 of the optical waveguide 2 of the PLC 100A passes through the cores 3 for four channels to propagate from the exit region E2 to an abutting and coupling portion. Then, light is coupled in the optical waveguide on the PD 6 side through this abutting and coupling portion, and then passes through the cores 3′ to be photoelectrically converted in the respective photoelectric conversion portions 3c′ for output as an electric signal.

In the meanwhile, an optical adhesive can be introduced into the connected portion for securing and fixing the PLC 100A and the PD 6 to achieve mechanical adhesion between the PLC 100A and the PD 6 and matching of the difference in refractive index. On this occasion, if the groove portions 40 on both the sides of the core 3 extend through to the end surface of the substrate 1, it is conceivable that the optical adhesive flows into the groove portions 40 so that the difference in refractive index between both the underclad 2a and the overclad 2b and the medium that occupies the groove portions 40 is reduced. As a result, the effect of mode field reduction may not work sufficiently.

Therefore, in order to prevent the optical adhesive from flowing into the groove portions 40, it is effective to introduce a medium having a refractive index lower than that of the underclad 2a and the overclad 2b into the groove portions 40 in advance before connection to the PD 6. The example described with reference to FIG. 4 adopts a structure in which the linear recesses 40b of the groove portions 40 on both the sides of the core 3 do not extend through to the end surface of the substrate 1, but have a wall formed to a position offset from the end surface of the substrate 1. A structure in which the optical adhesive is prevented from flowing in to prevent the difference in refractive index from being reduced is thereby obtained.

Note that although it is common to use a resin that is transparent in accordance with a used wavelength band for coupling of the above-described PLC 100A and the PD 6, operations and effects of the first embodiment do not depend thereon. For example, if a technique of fusion splicing the end surfaces using a YAG laser or the like after aligning the optical waveguides is adopted, the possibility that the resin enters the inside of the groove portions 40 can be eliminated, and a stable optical coupling structure can be formed.

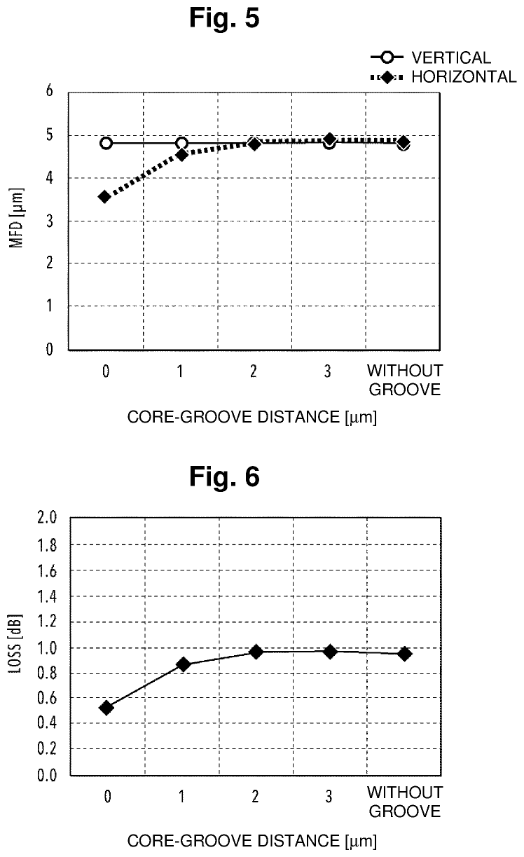

FIG. 5 is a drawing illustrating a correspondence relation between a result of inputting light to the PLC 100A and measuring the mode field diameter [μm] at the end surface of the substrate 1 of the optical waveguide 2 for each channel and the distance d [μm] between a side surface of the core 3 and an adjacent side surface of the groove portions 40. Note that herein light having a wavelength of 1.55 μm shall be input to the PLC 100A via fibers to obtain a result including a conventional case in which the groove portions are not provided.

It has been found from FIG. 5 that, in the case in which the groove portions are not provided, the mode field diameter in the vertical direction and the horizontal direction of the substrate 1 is about 4.8 μm. In contrast, in the case in which the groove portions 40 are provided on the exit region E2 side of the optical waveguide 2, it has been found that the mode field diameter in the horizontal direction slightly decreases when the distance d between a side surface of the core 3 and an adjacent side surface of the linear recess 40b of the groove portions 40 ranges from 3 μm to 2 μm. Furthermore, it has been found that when the distance d is reduced to 0 μm, the mode field diameter in the vertical direction remains substantially constant, while the mode field diameter in the horizontal direction can be significantly reduced to about 3.6 μm. The mode field diameter of about 3.6 μm in the horizontal direction when the distance d is 0 μm is a value made closer to the mode field diameter of the core 3′ of the optical waveguide of the PD 6.

FIG. 6 illustrates a result of obtaining light receiving sensitivity from a photocurrent of each channel of the PD 6 measured when coupling the PLC 100A and the PD 6, and calculating optical coupling loss ‘Loss’ [dB] for the above-described distance d [μm]. Note that herein a result of calculating the optical coupling loss ‘Loss’ [dB] for the distance d [μm] shall be obtained from the light receiving sensitivity of the PD 6 alone including the conventional case in which the groove portions are not provided.

It has been found from FIG. 6 that, in the case in which the groove portions are not provided, an optical coupling loss of slightly less than 1 dB occurs. In contrast, in the case in which the groove portions 40 are provided on the exit region E2 side of the optical waveguide 2, it has been found that the optical coupling loss is slightly reduced when the distance d between a side surface of the core 3 and an adjacent side surface of the linear recess 40b of the groove portions 40 ranges from 3 μm to 2 μm, and when the distance d is further reduced to 0 μm, the optical coupling loss can be reduced to about 0.5 dB. It is indicated that such a structure of the groove portions 40 can be introduced as it is into the conventional optical waveguide 2 in which the groove portions are not provided as illustrated in FIG. 1, and the mode field diameter in the optical waveguide 2 can be simply reduced without introducing a complicated structure.

It has been found from the above results that, even if abutting on and coupling to the PD 6 with an optical waveguide having a small mode field diameter is performed when coupling the PLC 100A and the PD 6, the optical coupling loss can be reduced. That is, it has been confirmed that the effect of reducing the optical coupling loss when coupling the optical waveguide component 10A according to the first embodiment and the optical element 20, and furthermore, the effect of reducing the optical coupling loss when coupling the PLC 100A to which the optical waveguide component 10A has been applied and the PD 6. Consequently, the optical waveguide component 10A according to the first embodiment enables the optical waveguides to be coupled simply at low optical coupling loss when configuring a photoelectron integration device by means of hybrid integration by coupling the optical element 20. Thus, application to an optical device from which lower optical loss is required becomes effective.

In conclusion, in the optical waveguide component 10A according to the first embodiment, the groove portions 4 deeper than the core 3 are provided in parallel on both the sides of the core 3 of the optical waveguide 2 in the direction in which the optical waveguide 2 that covers the core 3 extends. Then, the refractive index of a medium that occupies these groove portions 4 is made lower than the refractive index of the underclad 2a and the overclad 2b to equivalently increase the difference in refractive index between the core 3 and both the underclad 2a and the overclad 2b. Accordingly, confinement of light propagating through the core 3 of the optical waveguide 2 can be enhanced, and the mode field of the propagating light can be adjusted so as to be smaller. As a result, the above-described operations and effects are exerted.

### Second Embodiment

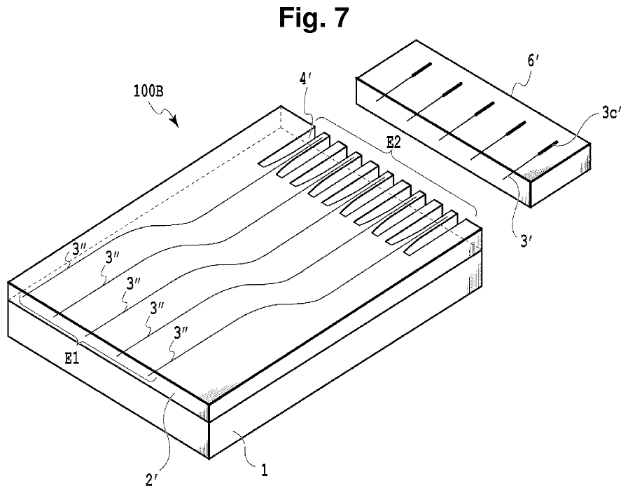

FIG. 7 is a perspective view illustrating a manner of optically coupling a PLC 100B according to a second embodiment of the present invention and a PD 6′ which is an application example of the optical element 20. This PLC 100B is different from the PLC 100A in that the number of channels of multiple-structure cores 3″ of an optical waveguide 2′ and the total number of groove portions 4′ are increased, and an angle θ formed by the optical waveguide 2′ and the end surface of the substrate 1 is set at an inclination. That is, in this PLC 100B, the number of channels of the multiple-structure cores 3″ of the optical waveguide 2′ is increased to five, the total number of the groove portions 4′ is increased to ten, and the angle θ formed by the cores 3″ of the optical waveguide 2′ and the end surface of the substrate 1 is set at an inclination of eight degrees with reference to ninety degrees. In addition, an optical waveguide of the PD 6′ for optical input is also set at the same inclination.

The structure of the groove portions 4′ in this PLC 100B is different in detail from the structure of the groove portions 40 described with reference to FIG. 4, and the groove portions 4′ are structured to have a total length of 750 μm, extend through to the end surface of the substrate 1 on the optical output side, and have no wall. However, the shape of the groove portions 4′ is the same in that a tapering recess 4a′ and a linear recess 4b′ are formed continuously, and the width is minimized at an end of the tapering recess 4a′ on the opposite side of and most distant from the end surface of the substrate 1. Note that herein the distance between a side surface of the core 3″ of the optical waveguide 2′ in the horizontal direction of the substrate 1 and an adjacent side surface of the groove portions 4′ provided on both the sides of the core 3″ can also be defined based on the width of the core 3″. It is also preferable that such a distance be less than or equal to ½ of the width of the core 3″ in the direction vertical to the extending direction of the core 3″ and more than zero.

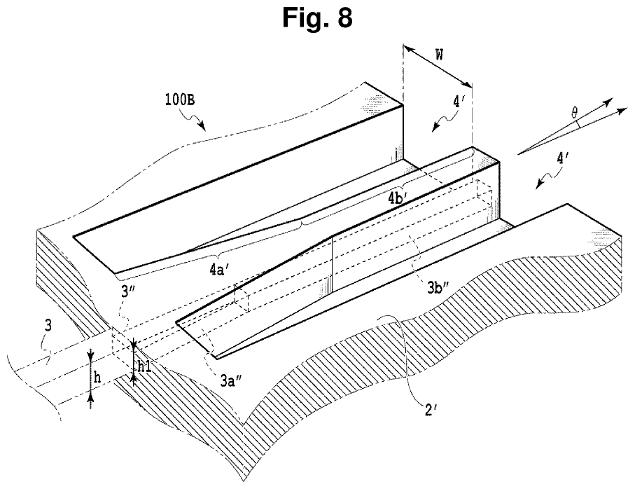

FIG. 8 is a partially broken perspective view illustrating a detailed structure of the optical waveguide 2′ of the PLC 100B illustrated in FIG. 7 on the exit region E2 side. The groove portions 4′ are also shaped to have the tapering recess 4a′ and the linear recess 4b′, the linear recess 4b′ having a length of 250 μm, the tapering recess 4a′ having a length of 500 μm, and are filled with air having a refractive index lower than the refractive index of the clad material. However, the dimensions and shapes of the tapering recess 4a′ and the linear recess 4b′ indicate a mere example, and can be changed arbitrarily.

Furthermore, the multiple-structure core 3″ is configured as a triple structure in which a quadrangular plate-like portion 3a″ having a tapering shape and a linear quadrangular plate-like portion 3b″ that form a double structure are coupled to a position of the linear portion extending from the S-shaped portion of the core 3 to serve as an end. The distance d between a side surface of the linear quadrangular plate-like portion 3b″ of the core 3″ and an adjacent side surface of the linear recess 4b′ of the groove portion 4′ is set constantly at 1.5 μm. Note that the width W of the linear recess 4b′ of the groove portion 4′ is set at 50 μm. Herein, if the overclad 2b present on the side surfaces of the core 3″ is etched, a structure in which the width W of the groove portions 4′ is not defined may also be embodied. However, considering the role of preventing the optical coupling end surface including the core 3″ from being damaged by contact when performing abutting on and coupling to the PD 6′, a structure is more desirable in which the clad is left on both the sides of the core 3″ with the interposition of the groove portions 4′ at the optical coupling end surface. This optical waveguide 2′ also has a structure in which the groove portions 4′ are not provided on both the sides of the core 3″ in a section from the optical circuit region to the input/output region at the optical coupling end surface where the groove portions 4′ are provided, and has a structure in which the clad is left on both the sides of the core 3″ in the input/output region with the interposition of the groove portions 4′. In conclusion, the optical circuit region of the optical waveguide 2′ is provided with the groove portions 4′ only in a necessary portion, and the groove portions 4′ are not provided on both the sides of the core 3″ in the entire region. In this respect, the same applies to the optical waveguide 2 according to the first embodiment.

In addition, the tapering structure of the tapering recess 4a′ of the groove portion 4′ is set such that the distance d between side surfaces of the linear quadrangular plate-like portion 3b″ and the quadrangular plate-like portion 3a″ of the core 3″ and an adjacent side surface of the tapering recess 4a′ of the groove portion 4′ increases gradually toward the opposite side of the end surface of the substrate 1. This distance d between a side surface of the core 3″ and an adjacent side surface of the tapering recess 4a′ of the groove portion 4′ is 10 μm presenting a maximum value at an end of the tapering recess 4a′ on the opposite side of the end surface of the substrate 1.

Furthermore, as to the width of the core 3″ in the horizontal direction of the substrate 1 within a regional range of the tapering recess 4a′ of the groove portion 4′, a structure tapering from the constant width of 4.5 μm of the linear quadrangular plate-like portion 3b″ is also adopted for the quadrangular plate-like portion 3a″ coupled to the linear quadrangular plate-like portion 3b″. That is, the tapering structure is adopted for the quadrangular plate-like portion 3a″ so as to gradually become smaller toward the position coupled to the linear quadrangular plate-like portion 3b″.

In addition, a height h1 of the core 3″ in the vertical direction of the substrate 1 from the quadrangular plate-like portion 3a″ of the core 3″ for which the tapering structure is adopted to the linear quadrangular plate-like portion 3b″ is set at 3 μm. This height h1 is set lower than a height h of 4.5 μm of the core 3 to be coupled to the double structure illustrated in FIG. 8. In addition, it is desirable that the height h1 be smaller than the height of the core 3′ of the PD 6′. The triple structure of the core″ having such two-step heights can be formed usually by, after forming the core 3 having the height h, adding a step of masking a region other than the region in which the tapering structure of the quadrangular plate-like portion 3a″ and the linear quadrangular plate-like portion 3b″ that form the double structure are to be formed to perform dry etching. Although this requires an additional step, the underclad 2b around the linear quadrangular plate-like portion 3b″ is also etched at the same time, which brings an additional effect that the etching time in dry etching when forming the groove portions 4′ thereafter can be shortened.

Besides, in the PLC 100B, in order to control reflected return light from the coupling interface of the core 3″, the angle θ formed by the core 3″ of the optical waveguide 2′ and the end surface of the substrate 1 is set at an inclination of eight degrees (with reference to ninety degrees). Then, for the cores 3″ for five channels illustrated in FIG. 7, the width of the linear quadrangular plate-like portion 3b″ of the core 3″ on the exit region E2 side is set at 2 to 4 μm.

In the PD 6′ to be abutted on and coupled to the PLC 100B having such a structure, the optical waveguide inclined at eight degrees is provided with a spot-size converter. Describing specifically with reference to FIG. 7, the core 3′ whose mode field diameter at full width at which the intensity of a light intensity distribution is 1/e² is 3 μm in each of the vertical direction and the horizontal direction of the chip is intended for optical input, and is coupled to the photoelectric conversion portion 3c′. Light input to the core 3′ through the spot-size converter propagates through the optical waveguide of the PD 6′ inclined at eight degrees, and is converted into an electric signal in the photoelectric conversion portion 3c′. Note that the light receiving sensitivity of the PD 6′ alone excluding optical coupling loss is 1.0 A/W at a wavelength of 1.55 μm.

Prior to abutting and coupling the PD 6′ to the PLC 100B, the groove portions 4′ on the side surfaces of the linear quadrangular plate-like portion 3b″ of the core 3″ on the exit region E2 side of the PLC 100B are filled with silicone resin. After thereby securing and curing, a connection surface is formed by dicing, polishing, and the like. In abutting and coupling of the PD 6′, the positions of the optical waveguide 2′ of the PLC 100B and the optical waveguide of the PD 6′ are aligned so as to maximize the light receiving sensitivity of the PD 6′ for light output from the linear quadrangular plate-like portion 3b″ of the core 3″ of the PLC 100B. Then, a resin that is transparent in an infrared region close to the refractive indices of the core 3″ and the underclad 2a and the overclad 2b of the PLC 100B is filled between the PLC 100B and the PD 6′. Then, the resin is cured to achieve securing and fixation. A photoelectron integration device can be configured in this manner. However, herein an antireflection film corresponding to the refractive index of the resin to be charged is also preferably provided on the end surface to serve as the optical waveguide of the PD 6′.

When the resin is removed after fixation with the resin, fixation can be achieved while preventing the resin from entering the groove portions 4′. Herein, the case in which silicone resin is used and removed after fixation is shown as an example. However, in a case in which a resin having a refractive index lower than that of the underclad 2a and the overclad 2b is used to fill the groove portions 4′, it is not necessary to remove the resin after fixation.

In the PLC 100B according to the second embodiment, in order to prevent the core 3″ of the optical waveguide 2′ from being contaminated by the resin to be filled, the distance d between the linear quadrangular plate-like portion 3b″ of the core 3″ on the exit region E2 side and the groove portion 4′ is set at 1.5 μm such that the core 3″ is not exposed. Note that in a structure in which the core 3″ is exposed, the refractive index of the core 3″ varies by the influence of a water content or the like, which may cause property deterioration. Thus, from the perspective of reliability, it is desirable that the distance d between the linear quadrangular plate-like portion 3b″ of the core 3″ and the groove portion 4′ be not zero. In order to achieve such a structure, a technique such as forming the groove portion 4′ such that the clad is left on the side surfaces of the core 3″ in advance, or after forming the groove portion 4′, forming a surface protection film of a material such as SiO₂ through the CVD method, sputtering method, or the like can be applied.

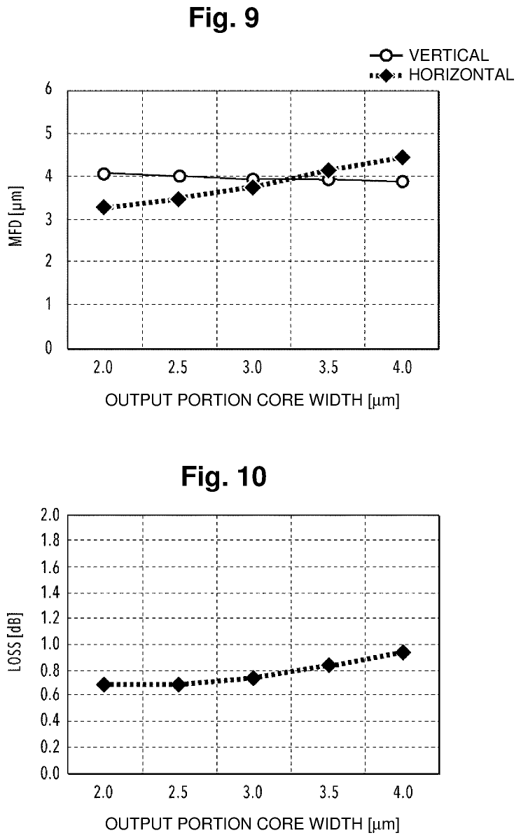

FIG. 9 is a drawing illustrating a correspondence relation between a result of inputting light to the PLC 100B and measuring the mode field diameter [μm] at an end surface of the substrate 1 of the optical waveguide 2′ for each channel and the width [μm] of the core 3 on the exit region E2 side. Note that herein light having a wavelength of 1.55 μm shall be input to the PLC 100B via fibers.

It has been found from FIG. 9 that, since the height h1 of the double structure portion of the triple-structure core 3″ is set at 3 μm, the mode field diameter in the vertical direction of the substrate 1 starts decreasing when the height h of the core 3 is 4.5 μm, and reaches about 4.0 μm. In addition, as the width of the core 3″ decreases, the mode field diameter in the vertical direction of the substrate 1 slightly increases from 3.9 μm to 4.1 μm. In contrast, the mode field diameter in the horizontal direction of the substrate 1 is significantly reduced from 4.4 μm to 3.2 μm. From these results, it has been found that in the PLC 100B, the mode field diameters in the horizontal direction and the vertical direction become smaller than in the case in which the groove portions are not provided to approach the mode field diameter of the optical waveguide of the PD 6′ for optical input.

FIG. 10 illustrates a result of obtaining light receiving sensitivity from a photocurrent of each channel of the PD 6′ measured when coupling the PLC 100B and the PD 6′, and calculating the optical coupling loss ‘Loss’ [dB] with respect to the width of the core 3″ in the above-described exit region E2. Note that herein the result shall be obtained by calculating the optical coupling loss ‘Loss’ [dB] from the light receiving sensitivity of the PD 6 alone.

It has been found from FIG. 10 that the optical coupling loss having been approximately 0.9 dB when the width of the core 3″ is 4 μm is reduced to less than or equal to 0.7 dB by making the width of the core 3″ less than or equal to 2.5 μm. In the first embodiment, even when the distance d between a side surface of the core 3 and an adjacent side surface of the linear recess 40b of the groove portion 40 is 1 μm, the optical coupling loss is reduced to approximately 0.8 dB, while if the structure of the second embodiment is applied, the optical coupling loss can be reduced further. That is, the characteristic of the structure of the second embodiment is a structure in which a thin clad is provided between the core 3″ and the groove portions 4′ such that the side surfaces of the core 3″ are not exposed to an external environment.

The effects of the optical coupling loss produced by the structure of the second embodiment include reduction of conversion loss of the mode field diameter (by about 0.5 dB) achieved by changing the height of the multiple structure of the core 3″ of the optical waveguide 2′ of the PLC 100B. By introducing the structure (the multiple structure of the core 3″) of the optical waveguide 2′ that reduces this loss, the optical coupling loss can be reduced further. From these results, the effects of reducing the optical coupling loss according to the second embodiment can be confirmed.

Furthermore, the effects of optical coupling loss produced by the structure of the second embodiment include prevention of occurrence of reflected return light associated with coupling of the multiple-structure core 3″ of the optical waveguide 2′. That is, depending on the material of each portion used and a difference in design of the optical waveguide 2′, a difference in refractive index occurs between the optical waveguide component and the optical element. Particularly since an optical coupling distance is short in abutting and coupling by the influence of reflection occurring at the refractive index interface, reflected return light that is not preferable for a communication device is likely to occur. This occurs when part of light reflected by the refractive index interface is coupled to the optical waveguide 2′ when returning to the optical waveguide component. Since the reflected return light greatly affects the transmission quality of an optical signal, loss of more than or equal to 30 to 40 dB is required particularly in a case of applying the optical waveguide component to an optical communication system. In order to reduce this reflected return light, the angle θ of the optical waveguide 2′ with respect to the vertical direction of the end surface of the substrate 1 is set at eight degrees in the structure of the second embodiment. Note that it is favorable that the above-described angle θ be more than or equal to eight degrees, but it is merely intended to prevent occurrence of reflected return light associated with coupling of the multiple-structure core 3″, and an excessive inclination more than necessity is not indicated.

As described above, in the PLC 100B according to the second embodiment, a height change in the multiple-structure core 3″ of the optical waveguide 2′ and setting the inclination angle of the optical waveguide 2′ with respect to the vertical direction of the end surface of the substrate 1 are introduced in addition to the configuration described in the first embodiment. As a result, when configuring a photoelectron integration device by means of hybrid integration by coupling an optical element having an optical waveguide, optical waveguides can be coupled simply at lower optical coupling loss than in the case of the first embodiment. Consequently, application to an optical device from which lower optical loss is required is more effective.

1. An optical waveguide component including an optical waveguide on a main surface of a substrate, the optical waveguide having an underclad, a core, and an overclad as laminated, and enabling a signal to be input/output to/from an optical element coupled to a vicinity of an end surface of the substrate, the optical waveguide component comprising:
groove portions on both sides of the core of the optical waveguide in a vicinity of the end surface of the substrate in a horizontal direction, the groove portions being formed deeper than the core in a cross-sectional direction with respect to a vertical direction of the substrate, and provided in parallel in an extending direction of the optical waveguide that covers the core, wherein
a refractive index of a medium that occupies the groove portions is lower than a refractive index of the underclad and the overclad.

2. The optical waveguide component according to claim 1, wherein
a width of the core in the optical waveguide of the substrate is smaller than a width of a core of an optical waveguide included in the optical element which is a coupling destination.

3. The optical waveguide component according to claim 1, wherein
the groove portions have a tapering shape such that a distance between a side surface of the core of the optical waveguide in the horizontal direction of the substrate and an adjacent side surface of the groove portions provided on both the sides of the core decreases from an opposite side of the end surface of the substrate toward the end surface.

4. The optical waveguide component according to claim 1, wherein
the groove portions provided on both the sides of the optical waveguide of the substrate are formed to a position offset from the end surface without extending through to the end surface of the substrate, and have a wall.

5. The optical waveguide component according to claim 1, wherein
an angle formed by the optical waveguide and the end surface of the substrate in the horizontal direction of the substrate is inclined at more than or equal to eight degrees with reference to ninety degrees.

6. The optical waveguide component according to claim 1, wherein
a height of the core in the optical waveguide of the substrate in the vertical direction of the substrate is smaller than a height of a core of an optical waveguide included in the optical element which is a coupling destination in the vertical direction.

7. The optical waveguide component according to claim 1, wherein
a distance between a side surface of the core of the optical waveguide in the horizontal direction of the substrate and an adjacent side surface of the groove portions provided on both the sides of the core is less than or equal to ½ of a width of the core in a direction vertical to an extending direction of the core and is more than zero.

8. The optical waveguide component according to claim 1, wherein
the optical waveguide has a structure in which the groove portions are not provided on both the sides of the core in a section from an optical circuit region to reach an input/output region at an optical coupling end surface in which the groove portions are provided, and has a structure in which a clad resulting from at least either of the underclad and the overclad is left in the input/output region with an interposition of the groove portions on both the sides of the core.
